(19) United States
(12) Patent Application Publication
(10) Pub. No.: US 2015/0214655 A1
(43) Pub. Date: Jul. 30, 2015

(54) CONNECTOR

(71) Applicant: YAZAKI CORPORATION, Tokyo (JP)

(72) Inventors: Shigeo Mori, Kakegawa-shi (JP); Masayuki Kataoka, Kakegawa-shi (JP); Fuminori Sugiyama, Kakegawa-shi (JP); Yoshitaka Koda, Kakegawa-shi (JP)

(73) Assignee: YAZAKI CORPORATION, Tokyo (JP)

(21) Appl. No.: 14/413,943

(22) PCT Filed: Jul. 11, 2013
(86) PCT No.: PCT/JP2013/069029

§ 371 Date: Jan. 9, 2015

(30) Foreign Application Priority Data
Jul. 11, 2012 (JP) 2012-155558

(51) Int. Cl. H01R 13/58

(52) U.S. Cl. CPC H01R 13/5845

(57) ABSTRACT

A connector (11) includes: terminals (17) which are fixed to conductors (15) of covered wires (13), respectively; sealing portions (21) which respectively integrally cover adjacent portions of the respective terminals (17) arranged side by side and sheaths (19) of corresponding covered wires (13), and which are made of an insulating and elastic material which links the sealing portions (21) by link portions (27); and a housing (23) which is made of an insulating resin having rigidity higher than the elastic material, and which integrally covers whole of the sealing portions (21).

### TECHNICAL FIELD

The present invention relates to a connector.

### BACKGROUND ART

Among known connectors that allow electric wires to penetrate through a wall in a watertight manner are ones in which electric wires are covered with a soft resin member which is covered with a housing made of a hard resin material (refer to Patent Document 1).

As shown in FIG. 5, a shield connector 501 is configured in such a manner that a conductive cylinder 507 is fixed (and electrically connected) to a conductive flange 505 which can be fixed to a shield wall 503 in an electrically continuous manner and the conductive cylinder 507 is electrically connected to a shield layer 511 of a shield wire 509. The shield connector 501 is produced in the following manner. First, in a first molding step using a die (not shown), a waterproof cylindrical body 515 made of a soft resin (e.g., urethane resin) is molded in such a manner as to be fitted with a sheath 513 of a shield wire 509. Subsequently, in a second molding step, a housing 519 made of a hard resin is molded in such a manner as to be fitted with the waterproof cylindrical body 515, the sheath 513, a shield layer 511, and a core 517. Finally, an O-ring 521 is attached to an outer circumferential portion of the housing 519. In the shield connector 501, the waterproof cylindrical body 515 which is disposed so as to cover the boundary between the housing 519 and the shield wire 509 keeps watertight the boundary between the inner surface of the housing 519 and the outer surface of the shield wire 509. Therefore, entrance of liquid such as water into the housing along the shield wire 509 can be prevented.

### PRIOR ART DOCUMENT(S)

### Patent Document(s)

Patent Document 1: JP-A-2001-273946

### SUMMARY OF THE INVENTION

### Problem to be Solved by the Invention

However, in the shield connector 501 in which the waterproof cylindrical body 515 made of a relatively soft urethane resin is fitted with an end portion of the shield wire 509 and covered with the cylindrical housing 519, if a portion, exposed from the housing 519, of the waterproof cylindrical body 515 is deformed so as to continue to conform to the shield wire 509, peeling may occur at the boundary between the exposed portion of the waterproof cylindrical body 515 and the sheath 513 in the case where the adhesion between the waterproof cylindrical body 515 and the sheath 513 is weak. Peeling at the boundary between the waterproof cylindrical body 515 and the sheath 513 may impair the waterproof performance.

The present invention has been made in view of the above circumstances, and an object of the present invention is therefore to provide a connector that is highly reliable in terms of the waterproof function by suppressing peeling at a boundary due to a bend of an electric wire.

### Solutions to the Problem

(1) A connector including: a plurality of terminals which are fixed to conductors exposed from end portions of covered wires, respectively; sealing portions which respectively integrally cover adjacent portions of the respective terminals arranged side by side and sheathes of the corresponding cover wires, and which are made of an insulating and elastic material which links the seal portions by a link portion; and a housing which is made of an insulating resin having rigidity higher than the elastic material, and which integrally covers whole of the sealing portions provided around the end portions of the covered wires.

In the connector having the configuration of item (1), the whole of the sealing portion provided around the end portion of the covered wire is covered with the insulating resin. Therefore, stress produced by a wire bend is not transmitted to the boundary between the sheath of the covered wire and the sealing portion and peeling at the boundary can be suppressed. Furthermore, the end portions of the plurality of covered wires to which the respective terminals are fixed can be positioned with respect to each other by the link portion of the sealing portions.

Since the sealing portions that have been attached to the respective end portions of the plurality of covered wires by primary molding are then covered with the housing, the end portions of the plurality of covered wires to which the respective terminals are fixed can be positioned accurately in the cavity of a secondary molding die when secondary molding is performed using the insulating resin. Therefore, the efficiency of molding work is increased and a connector having accurate dimensions can be produced.

(2) The connector having the configuration of item (1), wherein a plurality of link portions are arranged in a longitudinal direction of the covered wires.

According to the connector having the configuration of item (2), the interval between axial lines of the sealing portions is made constant, and the axial lines are given a high degree of parallelism, whereby relative positioning can be made more stably.

The invention has been described above concisely. The details of the invention will become more apparent when the section “modes for carrying out the invention” (hereinafter referred to as an embodiment) described below is read through with reference to the accompanying drawings.

### BRIEF DESCRIPTION OF THE DRAWINGS

FIG. 1 is a plan view of a connector according to an embodiment of the invention.

FIG. 2 is a side view of the connector shown in FIG. 1.

FIG. 3 is a plan view of the connector shown in FIG. 1 with a housing removed.

FIG. 4 is a horizontal sectional view of an injection molding die for molding of the housing shown in FIG. 1.

FIG. 5 is a vertical sectional view of a conventional connector.

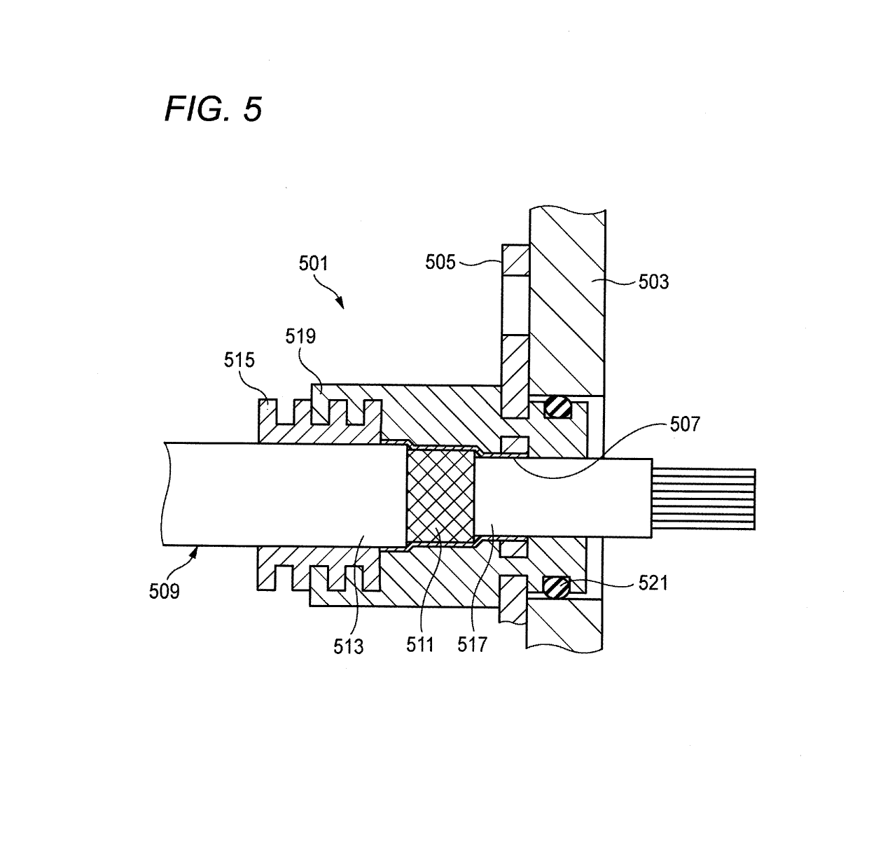

### MODE FOR CARRYING OUT THE INVENTION

An embodiment of the present invention will be hereinafter described with reference to the drawings.

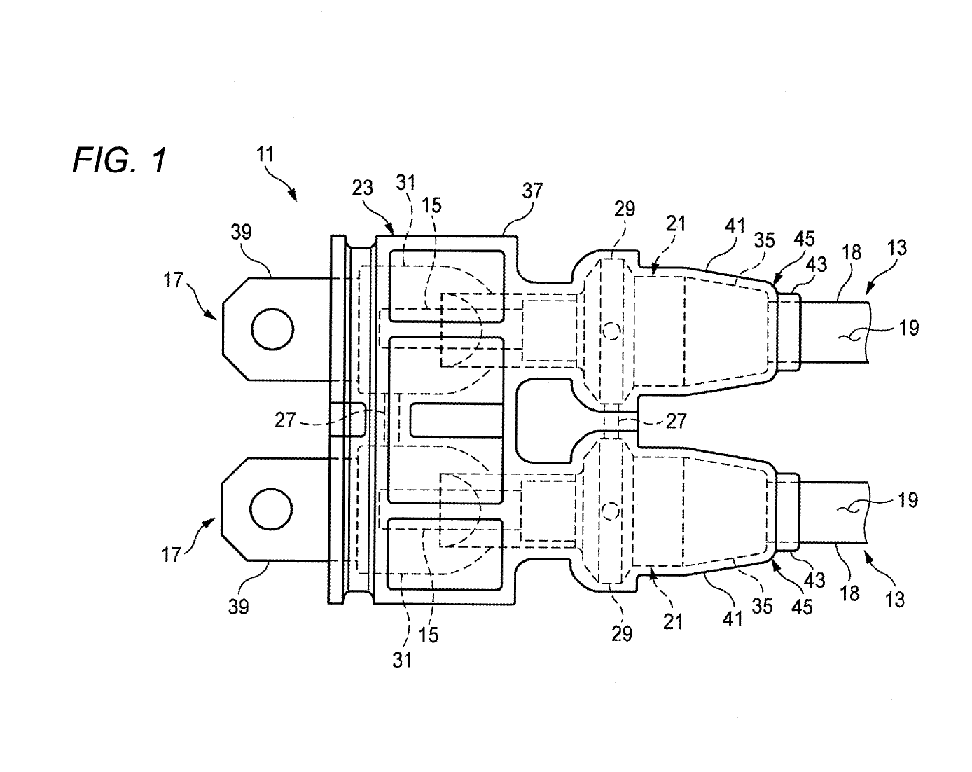

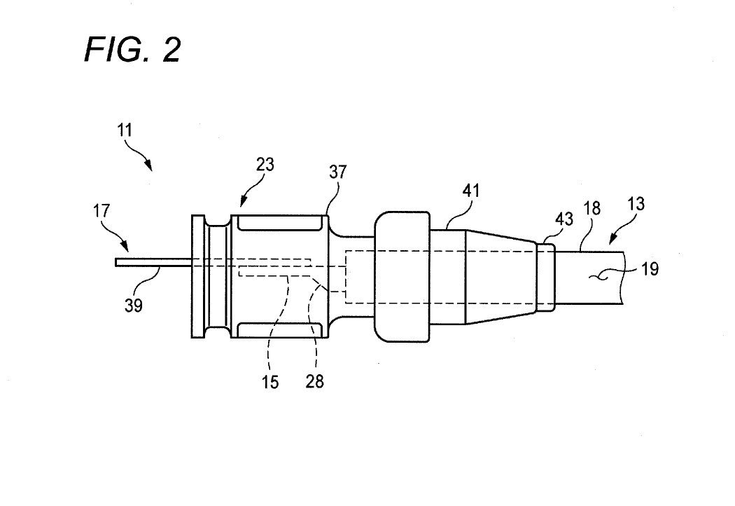

As shown in FIGS. 1 and 2, a connector 11 according to the embodiment is so called an overmolded connector, in which a terminal 17 is connected to a conductor 15 of each covered wire 13, and the connected portion, that is, an end portion 18 of the covered wire 13 and a part of the terminal 17, is covered with resin molds. In this specification, the connector 11 will be described with its terminal side and covered wire side referred to as the front side and the read side, respectively.

The covered wire 13 having the conductor 15 covered with a sheath 19 is connected to the connector 11 according to the embodiment. The covered wire used in the invention may be either a covered wire 13 having the conductor 15 covered with only a sheath 19 or a shield wire in which the outer surface of an internal insulating sheath covering a conductor is covered with a metal braid and the outer surface of the metal braid is covered with an outer sheath. The connector 11 according to the embodiment is provided for a plurality of (in the embodiment, two) covered wires 13 having conductors 15 connected to respective terminals 17 which are arranged side by side.

The terminal 17 is connected and fixed to the conductor 15 exposed from the end portion 18 of the corresponding covered wire 13. A connection structure of the terminal 17 and the conductor 15 may be any of a crimping structure, a pressure contact structure, a welding structure, a brazing structure, etc. Although in the embodiment a flat terminal which is a male terminal is employed as an example of the terminal 17, the terminal 17 may be a ring terminal, a Y-shaped terminal, a female terminal having a box-shaped electrical contact portion, or the like.

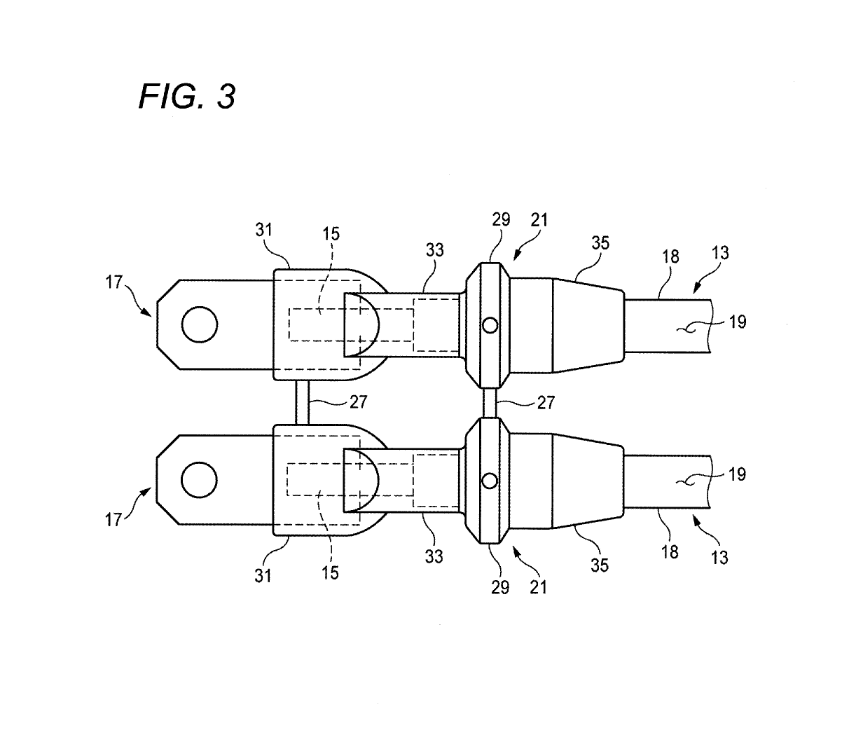

The connector 11 is produced in such a manner that conductors 15 and end portions 18 of covered wires 13 are subjected to primary molding using an insulating and elastic material such as a thermoplastic elastomer to form sealing portions 21 (see FIG. 3) and then the sealing portions 21 and the end portions 18 are subjected to secondary molding using an insulating resin such as a thermoplastic resin to form a housing 23 (see FIG. 1).

The sealing portions 21 are made of a thermoplastic elastomer and are linked to each other by link portions 27. The sealing portion 21 covers an adjacent portion 28 of each of the two terminals 17 separated from each other and arranged side by side and the sheath 19 of a corresponding one of the two covered wires 13 separated from each other and arranged side by side. A material capable of bonding the housing 23 to the sheaths 19 of the covered wires 13 easily is selected as the thermoplastic elastomer.

Thermoplastic elastomers can be modified so as to be able to be thermally bonded to thermoplastic resins having high polarity value (solubility parameter) such as an ordinary ABS resin and polycarbonate and to be superior in flexibility and moldability.

As shown in FIG. 3, the plurality of (in the embodiment, two) link portions 27 are arranged in the longitudinal direction of the covered wires 13. In the embodiment, the sealing portion 21 is formed with a flange 29 on the covered wire side and with a terminal mold portion 31 on the terminal side. Each sealing portion 21 is formed, between the terminal mold portion 31 and the flange 29, with a constricted portion 33 which is smaller in diameter than the terminal mold portion 31 and the flange 29. Each sealing portion 21 is further formed, on the covered wire side of the flange 29, with a waterproof cylinder 35 which covers an outer circumferential surface of the covered wire 13. The adjoining flanges 29 and the adjoining terminal mold portions 31 of the sealing portions 21 are linked to each other by the respective link portions 27.

The housing 23 is made of an insulating resin which has rigidity higher than the elastic material of the sealing portions 21 and integrally covers whole of the sealing portion 21 provided around the end portion 18 of the corresponding covered wire 13. That is, the housing 23 covers all of the terminal mold portions 31, the flanges 29, and the waterproof cylinders 35 of the two sealing portions 21 which are arranged side by side. The housing 23 is a housing body 37 which is approximately uniform in thickness, conforms to the outlines of the terminal mold portions 31, the flanges 29, and the waterproof cylinders 35, and is shaped like solid blocks between the terminal mold portions 31 and the flanges 29 (see FIG. 1). Thus, the housing body 37 is shaped in such a manner that electrical contact portions 39 of the terminals 17 project forward and the pair of waterproof cylinders 35 which are covered with the housing 23 extend rearward. As shown in FIG. 3, the covered wires 13 lead rearward out of the respective waterproof cylinders 35. Since the waterproof cylinders 35 are covered with the housing 23, the covered wires 13 directly lead out of respective waterproof cylinder sheaths 41 of the housing 23.

Each waterproof cylinder sheath 41 is formed with a small diameter portion 43 at its rear end, whereby a step portion 45 is formed. The small diameter portion 43 which covers an outer circumferential surface of the covered wire 13 is thin. In the connector 11 according to the embodiment, because of the presence of the thin small diameter portion 43, stronger adhesion is secured between each waterproof cylinder sheath 41 and the covered wire 13 than in a case that the covered wire 13 leads directly from the waterproof cylinder sheath 41 not having the small diameter portion 43. The small diameter portion 43 is made of the thermoplastic resin that is higher in rigidity than the thermoplastic elastomer. However, being thin, the small diameter portion 43 can follow a wire bend to some extent, that is, in such a range that peeling does not occur at the boundary between the waterproof cylinder 35 and the covered wire 13. That is, the small diameter portion 43 suppresses peeling at the boundary between the waterproof cylinder 35 and the covered wire 13 while allowing the covered wire 13 to bend together in such a range.

The above-described connector 11 is manufactured in the following manner. First, covered wires 13 in which terminals 17 are fixed to conductors 15 are set in a primary molding die (not shown) and sealing portions 21 shown in FIG. 3 are formed by primary molding.

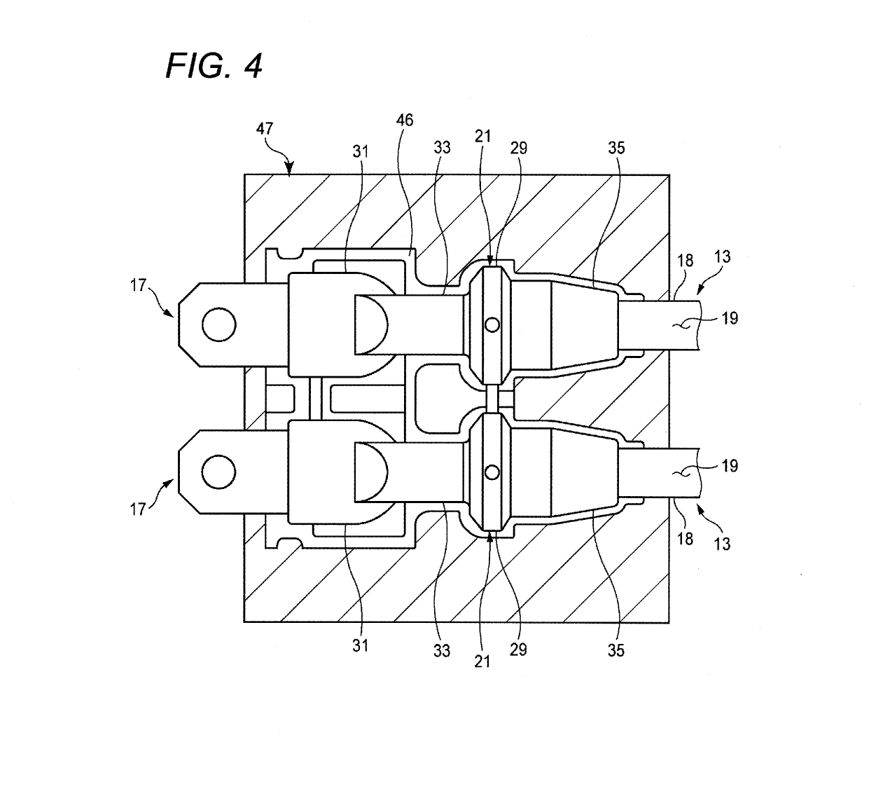

After the formation of the sealing portions 21 by the primary molding, the covered wires 13 with the sealing portions 21 are inserted into a cavity 46 of a secondary molding die (injection molding die) 47 shown in FIG. 4 and secondary molding is performed using an insulating resin, whereby a housing 23 shown in FIG. 1 is molded. That is, the sealing portions 21 are formed using a thermoplastic elastomer which is an elastic material and the housing 23 is formed using a thermoplastic resin which is an insulating resin.

The end portions 18 of the two covered wires 13 to which the respective terminals 17 are fixed can be positioned with respect to each other by the pair of sealing portions 21 which are linked to each other by the link portions 27. Since the sealing portions 21 that have been attached to the respective end portions 18 of the two covered wires 13 by the primary molding are then covered with the housing 23, the end portions 18 of the covered wires 13 to which the respective terminals 17 are fixed can be positioned accurately in the cavity 46 of the secondary molding die 47 when the secondary molding is performed using the insulating resin. As a result, the efficiency of molding work in which the end portions 18 of the covered wires 13 are set in the cavity 46 is increased. Furthermore, there does not occur an event that the end portions 18 of the covered wires 13 that are inserted in the cavity 46 are deviated by injection pressure that acts on the secondary molding resin (insulating resin) to render the thickness of the housing 23 not uniform. Thus, a connector 11 having accurate dimensions can be produced.

Next, a description will be made of workings of the connector 11 having the above configuration.

In the above-described connector 11, each sealing portion 21 provided around the end portion 18 of the covered wire 13 is fully covered with the insulating resin. Therefore, stress produced by a wire bend is not transmitted to the boundary between the sheath 19 and the sealing portion 21 and peeling at the boundary can be suppressed.

The end portions 18 of the two covered wires 13 to which the respective terminals 17 are fixed can be positioned with respect to each other by the link portions 27 of the sealing portions 21. Since the sealing portions 21 that have been attached to the respective end portions 18 of the two covered wires 13 by the primary molding are then covered with the housing 23, the end portions 18 of the two covered wires 13 to which the respective terminals 17 are fixed can be positioned accurately in the cavity 46 of the secondary molding die 47 when the secondary molding is performed using the insulating resin. Therefore, the efficiency of molding work is increased and a connector 11 having accurate dimensions can be produced.

By virtue of the two link portions 27 which are arranged in the longitudinal direction of the covered wires 13, the interval between the axial lines of the sealing portions 21 is made constant and the axial lines are given a high degree of parallelism, as a result of which the end portions 18 of the two covered wires 13 can be positioned with respect to each other more stably.

Furthermore, in the connector 11 according to the embodiment, the flanges 29 and the terminal mold portions 31, which are close to each other, of the adjoining sealing portions 21 are linked to each other by the respective link portions 27 having as short lengths as possible. As a result, the link portions 27 are hard to be deformed and hence the relative displacement between the sealing portions 21 due to deformation of the link portions 27 can be made small.

As is understood from the above description, in the connector 11 according to the embodiment, occurrence of peeling at the boundary between the housing 23 and the sealing portions 21 or the boundary between the sealing portions 21 and the sheaths 19 due to wire bends can be suppressed, whereby the connector 11 can be made highly reliable in terms of the waterproof function.

The features of the above-described connector according to the embodiment of the invention will be summarized below concisely:

[1] A connector 11 including: a plurality of terminals 17 which are fixed to conductors 15 exposed from end portions 18 of covered wires 13, respectively; sealing portions 21 which cover adjacent portions 28 of the respective terminals 17 arranged side by side and sheaths 19 of the corresponding covered wires 13, and which are made of an insulating and elastic material which links the sealing portions 21 by a link portion 27; and a housing 23 which is made of an insulating resin having rigidity higher than the elastic material, and which integrally covers whole of the sealing portions 21 provided around the end portions 18 of the covered wires 13.

[2] The connector 11 having the configuration of item [1], wherein a plurality of link portions 27 are arranged in a longitudinal direction of the covered wires 13.

The connector according to the invention is not limited the above-described one according to the above embodiment, and various modifications, improvements, etc. can be made as appropriate. And the material, shape, dimensions, number, location, etc. of each constituent element of the above embodiment are optional and no limitations are imposed on them as long as the invention can be implemented.

The present application is based on Japanese Patent Application No. 2012-155558 filed on Jul. 11, 2012, the disclosure of which is incorporated herein by reference.

### INDUSTRIAL APPLICABILITY

According to the connector of the invention, it is possible to provide a connector that is highly reliable in terms of the waterproof function by suppressing peeling at a boundary due to a bend of an electric wire.

### DESCRIPTION OF REFERENCE SIGNS

11: Connector

13: Covered wire

15: Conductor

17: Terminal

18: End Portion

19: Sheath

21: Sealing Portion

23: Housing

27: Link Portion

29: Flange

31: Terminal Mold Portion

1. A connector comprising:
a plurality of terminals which are fixed to conductors exposed from end portions of covered wires, respectively;
sealing portions which respectively integrally cover adjacent portions of the respective terminals arranged side by side and sheathes of the corresponding covered wires, and which are made of an insulating and elastic material which links the seal portions by a link portion; and
a housing which is made of an insulating resin having rigidity higher than the elastic material, and which integrally covers whole of the sealing portions provided around the end portions of the covered wires.

2. The connector according to claim 1,
wherein a plurality of the link portions are arranged in a longitudinal direction of the covered wires.
